(19) United States
(12) Patent Application Publication
(10) Pub. No.: US 2018/0173296 A1
(43) Pub. Date: Jun. 21, 2018

(54) DETERMINATION OF AN OPERATING RANGE OF A PROCESSOR USING A POWER CONSUMPTION METRIC

(71) Applicant: INTEL CORPORATION, Santa Clara, CA (US)

(72) Inventors: Noor U. Mubeen, Bangalore (IN); Harinarayanan Seshadri, Bangalore (IN); Rajeev D. Muralidhar, Bangalore (IN); Mahesh Kumar P, Bangalore (IN); Bharath K. Veera, Bangalore (IN)

(21) Appl. No.: 15/381,700

(22) Filed: Dec. 16, 2016

(51) Int. Cl. G06F 1/32

(52) U.S. Cl. CPC G06F 1/3287

(57) ABSTRACT

An apparatus is provided which comprises: a processing core; and circuitry to select, for a first mode of operation of the processing core, a first operating point comprising a first operating frequency and a first operating load, based at least in part on a mathematical function that substantially defines variation of a frequency and a load of the processing core for a threshold power consumption, wherein the circuitry is to select the first operating point such that a first power consumption of the processing core at the first operating point is less than or equal to the threshold power consumption.

### BACKGROUND

Dynamic frequency scaling is a technique in computer architecture whereby a frequency of a microprocessor can be automatically adjusted, e.g., either to conserve power or to reduce the amount of heat generated by a chip that includes the microprocessor. Usually, in dynamic frequency scaling, the frequency is scaled up to a maximum frequency, sometimes referred to as Highest Frequency Mode (HFM) frequency. For example, the frequency during a regular operation does not exceed the HFM frequency, although, for example, during a boosted operation, the frequency can temporarily exceed this maximum HFM frequency. For example, during the boosted operation, the maximum frequency that can be attained is referred to as maximum turbo frequency. A specification of a computing device often specifies the HFM frequency and the maximum turbo frequency of a processing core within the computing device.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a computing device comprising a processing core and an operating range determination logic to determine an operating range of the processing core, according to some embodiments.

FIG. 2 illustrates a three-dimensional (3D) plot depicting a relationship between a frequency, a load and a power consumption of a processing core, according to some embodiments.

FIG. 3 illustrates a 3D plot depicting a relationship between a frequency, a load and a power consumption of a processing core, where the plot is chopped along an isometric frequency line, according to some embodiments.

FIG. 4 illustrates a 3D plot depicting a relationship between a frequency, a load and a power consumption of a processing core, where the plot is chopped along an isometric power consumption line, according to some embodiments.

FIG. 5 illustrates a plot of a power surface of a processing core, with two parabolas being overlaid on the power surface, according to some embodiments.

FIG. 6 illustrates a general parabola in a U, V and Z plane, where a U axis corresponds to a frequency axis of FIG. 5, where a V axis corresponds to a load axis of FIG. 5, and where a Z axis corresponds to a power consumption axis of FIG. 5.

FIG. 7 illustrates a plot that represents a top view of the plot of FIG. 5, according to some embodiments.

FIG. 8 illustrates another plot that represents a top view of the plot of FIG. 5, according to some embodiments.

FIG. 9 illustrates a flowchart depicting a method for determining an operating range of a processing core using a power consumption metric, according to some embodiments.

FIG. 10 illustrates a smart device, a computing device or a computer system or a SoC (System-on-Chip), where an operating point management subsystem manages an operating point for a processor of a computing device, according to some embodiments.

### DETAILED DESCRIPTION

In a conventional system employing, for example, dynamic frequency scaling, an operating frequency for a regular operation of a processing core is limited by the HFM frequency. The processing core can operate beyond the HFM frequency temporarily, for example, during a boosted operation (e.g., a turbo boost operation). However, for regular operation, the processing core cannot exceed the HFM frequency. A specification of a computing device often advertises the HFH frequency and the maximum turbo frequency of a processing core within the computing device.

In some embodiments, instead of limiting a processing core by a maximum frequency, a regular operation of a processing core is limited by a maximum power consumption. For example, a three-dimensional (3D) plot depicting a relationship between a power consumption of a processing core, an operating frequency of the processing core, and a load of the processing core is generated. The 3D plot has several isometric power consumption lines. For example, the power consumption along an isometric power consumption line is substantially constant. An appropriate isometric power consumption line is selected, e.g., based on a maximum power consumption desired for the processing core for a regular active operation of the processing core. The selected isometric power consumption line divides the 3D plot in a first region and a second region. During the regular active mode of operation, the processing core is operated in the first region, where the power consumption is less than the maximum power consumption. During a turbo boost mode of operation, the processing core can be operated in the second region, where the power consumption is more than the maximum power consumption.

Furthermore, a mathematical function that substantially defines the selected isometric power consumption line is identified. The identification can be done, for example, by a curve fitting method, where a curve that best fits the selected isometric power consumption line is identified. As an example, the curve can be a parabola. Once the mathematical function is identified, the operating points of the processing core is selected to be within the first region (e.g., such a selection is performed based on the mathematical function).

There are many technical effects of the various embodiments. For example, conventional processing cores usually have the HFM frequency in which the processing cores normally operate (e.g., while it is not operating at a turbo boost mode). In contrast, the processing core discussed herein can go beyond the HFM frequency, and yet operate safely (e.g., as the power consumption is less than a maximum power consumption allowed for the processing core). In some embodiments, the processing core, thus, is not limited by a maximum frequency—rather, the processing core is limited by a better Quality of Service (QoS) criteria, e.g., the maximum power consumption. In an example, instead of, or in addition to advertising the HFM frequency, a computing device including the processing core can be advertised using a maximum power consumption, which, for example, can be a better QoS criteria for measuring performance.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.” The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C). The terms “left,” “right,” “front,” “back,” “top,” “bottom,” “over,” “under,” and the like in the description and in the claims, if any, are used for descriptive purposes and not necessarily for describing permanent relative positions.

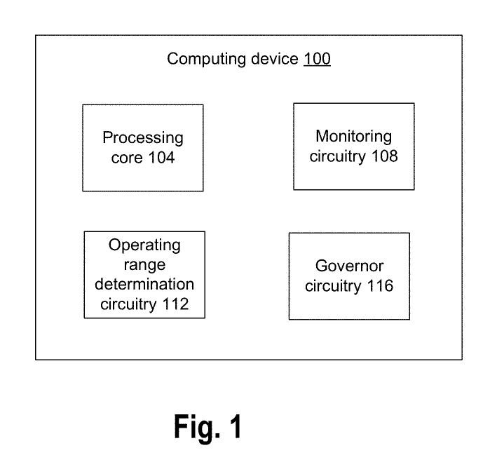

FIG. 1 illustrates a computing device 100 comprising a processing core 104 (henceforth also referred to as “core 104”) and an operating range determination logic 112 (henceforth also referred to as “logic 112”) to determine an operating range of the core 104, according to some embodiments. In some embodiments, the computing device further comprises a monitoring logic 108 (henceforth also referred to as “logic 108”), and a governor logic 116 (henceforth also referred to as “logic 116”).

A logic (e.g., the logic 108, 112 and/or 116) may encompass circuitry, e.g., hardware circuitry, firmware and/or software components. In some embodiments, a logic is implemented using solely hardware circuitry. In some embodiments, a logic is implemented using solely software. In some embodiments, a logic is implemented using a combination of hardware circuitry and software.

The computing device 100 can be any appropriate type of computing device, e.g., a laptop, a desktop, a smartphone or a cellular phone, a tablet, a wearable device, an Internet-of-things (IOT) device, a set-top box, or the like. Although FIG. 1 illustrates the computing device 100 comprising a single core 104, in another example, the computing device 100 can include multiple processing cores. Furthermore, the computing device 100 includes various other components, although these components are not illustrated in FIG. 1 for purposes of illustrative clarity.

The core 104 operates at an operating frequency using an operating voltage. At any given time, the core 104 utilizes certain amount of power (e.g., measured in milliWatts (mW) to operate at the operating frequency.

Furthermore, at any given time, the core 104 operates at a given load. In an example, the load is expressed as a percentage. Unless otherwise mentioned and for purposes of this disclosure, the load of the core 104 indicates a percentage of time the core 104 is operating in an active state. Merely as an example, for every 10 milliseconds (ms) interval, if the core 104 is at an active state for 2.5 ms in total, and is at an appropriate inactive state (e.g., at an appropriate idle power saving state, a sleep state, or the like) for the remaining 7.5 ms in total, then the core 104 is assumed to be operating at 25% load over the interval.

In some embodiments, the logic 112 determines an operating range of the core 104. For example, the logic 112 determines a range of frequency, a range of load and/or a range of power consumption within which the core 104 is to operate. In some embodiments, the circuit 116 scales the frequency and load of the core 104, e.g., based on a demand for computing resource, thermal management, etc., to determine an operating point (e.g., determine an operating voltage, an operating frequency, an operating load, etc.) of the core 104, such that the operating point of the core 104 is within the operating range determined by the logic 112, as will be discussed in further details herein later.

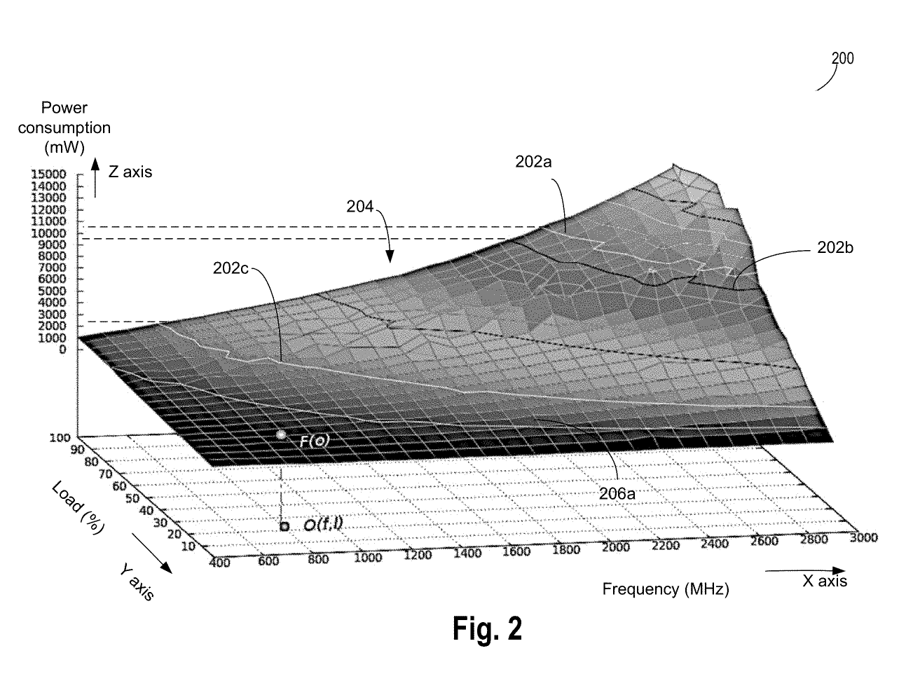

In some embodiments, the logic 108 monitors the operation of the core 104. For example, the logic 108 monitors an operating frequency, a load and/or power consumed by the core 104, e.g., as these parameters are varied over a given range. Such monitoring can be performed by any appropriate means available. In some embodiments, based on such monitoring, the logic 108 generates a three-dimensional (3D) plot depicting a relationship between the frequency, load and power consumption of the core 104. FIG. 2 illustrates a 3D plot 200 depicting the relationship between the frequency, the load and the power consumption of the core 104, according to some embodiments. The X axis in the plot 200 represents the frequency in megahertz (MHz), the Y axis represents the load of the core in percentage (%), and the vertical Z axis represents the power consumption of the core 104 in mW.

In some embodiments and as discussed herein above, the plot 200 (or at least a part of the plot 200) can be generated based on the logic 108 monitoring the operation of the core 104. In some other embodiments, the plot 200 (or at least a part of the plot 200) is generated by monitoring operations of one or more other cores (e.g., which can be external to the computing device 100), where the one or more other cores have similar characteristics and are of similar type as the core 104. In some other embodiments, the plot 200 (or at least a part of the plot 200) is generated by computer simulation of a model of the core 104. In yet other embodiments, the plot 200 is generated using a combination of these above discussed methods.

The plot 200, for example, illustrates a surface 204, which is also referred to herein as a “power surface” of the core 104. For example, if an operating load and an operating frequency of the core 104 is known, the surface 204 provides a power consumption by the core 104. Merely as an example, at point O on the surface 204, F(O) represents a power consumption, and O(f,l) represents a corresponding frequency and load.

As illustrated in FIG. 2, when the frequency and/or the load is relatively low, the power consumed is relatively low. The power consumption increases and is relatively high for relatively high values of load and frequency. For example, the top right corner of the surface 204 represents relatively high power consumption for relatively high values of load and frequency.

In FIG. 2, example lines 202a, 202b, 202c are labeled, where these lines represent isometric power consumption lines. For example, all points along the line 220a on the surface 204 has substantially similar power consumption, which is about 10500 mW (although, note that due to the 3D nature of the plot 200, the power consumption along the line 220a may visually appear to be different). In another example, all points along the line 220b on the surface 204 has substantially similar power consumption (e.g., is a little over 9500 mW), and all points along the line 220c on the surface 204 has substantially similar power consumption (e.g., about 2000 mW). There are many other isometric power lines in the plot 200, although these are not illustrated or labeled in FIG. 2. Because a specific isometric power consumption line has the same Z axis value at all points along the line, the lines 202a, 202b, 202c are parallel to the X-Y plane, e.g., are horizontal.

FIG. 2 also illustrates isometric frequency lines, along each of which the frequency is substantially similar; and also illustrates isometric load lines, along each of which the load is substantially similar. The isometric frequency lines are parallel to the Y axis, and the isometric load lines are parallel to the X axis (although, due to the 3D nature of the plot 200, visually these lines may not appear parallel to the corresponding axis). For example, line 206a is an isometric frequency line, and all points along the line 206a have substantially similar frequency (e.g., a frequency of about 2200 MHz).

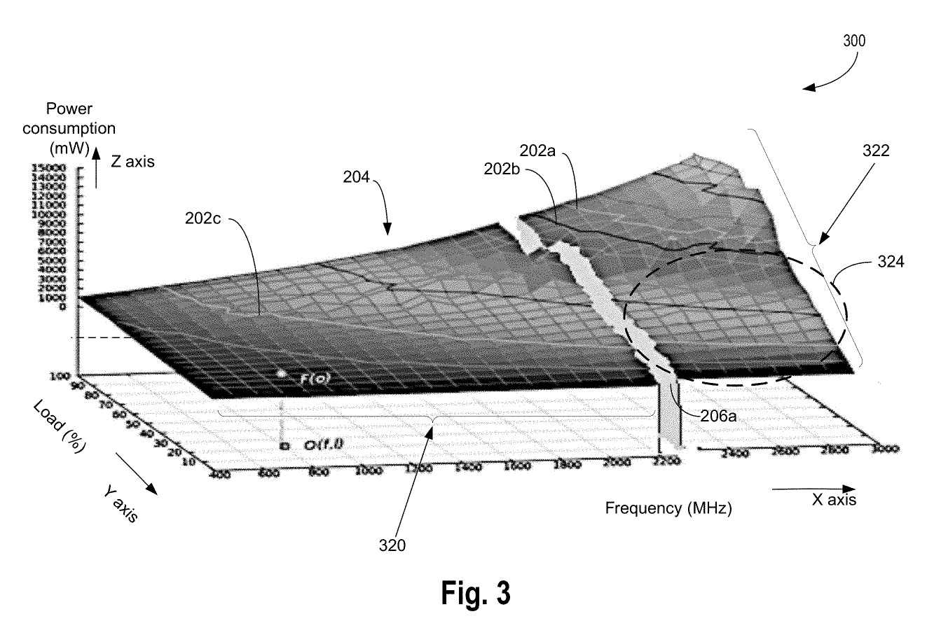

A conventional system (e.g., a system that utilizes dynamic frequency scaling) may use frequency as a main parameter to determine an operating point of a processing core. For example, the conventional system ensures that the operating frequency of the processing core does not exceed a maximum predetermined frequency (e.g., the HFM frequency), and dynamically scales the frequency under this maximum frequency. Such a concept of the conventional system (i.e., having a maximum frequency limit) is interpolated in the surface 204, as illustrated in FIG. 3.

FIG. 3 illustrates a 3D plot 300 depicting a relationship between a frequency, a load and a power consumption of a processing core, where the plot 300 is chopped along an isometric frequency line, according to some embodiments. The plot 300 of FIG. 3 is at least in part similar to the plot 200 of FIG. 2. For example, the plot 300 includes the isometric power consumption lines 202a, 202b, and 202c, and the isometric frequency line 206a having the frequency of about 2200 MHz. Additionally, the X, Y and Z axes and the surface 204 in both the plots 200 and 300 are similar, and are represented using similar labels.

The plot 300 of FIG. 3 is chopped in two regions along the isometric frequency line 206a, thereby dividing the surface 204 is a first region 320 and a second region 322. Points within the first region 320 has frequencies below the frequency of the isometric frequency line 206a, e.g., below 2200 MHz. Points within the second region 322 has frequencies above the frequency of the isometric frequency line 206a, e.g., above 2200 MHz. The frequency of the isometric frequency line 206a, for example, represents the HFM frequency.

As discussed herein above, a conventional system may limit a maximum operating frequency of a processing core, where the maximum frequency, for example, is about the same as the frequency of the isometric frequency line 206a of FIG. 3. Thus, the processing core of such a conventional system normally operates (e.g., operates during an active regular or normal mode of operation, while nor operating in a turbo boost mode of operation) within the first region 320. It is to be noted that, for example, during a turbo boost operation, the frequency can temporarily exceed this maximum operating frequency, and the system can temporarily operate in the region 322.

It is to be noted that within the second region 322, there is a region 324 with operating points that have relatively high frequency, but low load and low power consumption. The region 324 is approximately illustrated using a dotted oval shape, although such demarcation of the region 324 is merely an approximation and for purposes of illustration only. The region 324 includes those operating points on the surface 204 that have (i) frequencies higher than 2200 MHz (e.g., which is the frequency of the isometric frequency line 206a, along which the plot 300 is chopped) and (ii) relatively low power consumption (e.g., power consumption lower than the power consumption of the isometric power consumption line 202b).

As discussed herein above, the conventional system limits the maximum operating frequency of a processing core to the frequency of the isometric frequency line 206a. Thus, the processing core of such a conventional system normally operates within the first region 320, and does not normally operate within the region 324. However, the region 324 has relatively low power consumption, albeit having a high frequency. Accordingly, a processing core can safely operate within the region 324, without, for example, overloading the system or without generating excessive heat. However, a conventional system artificially limits the performance of the system by, for example, limiting the operating frequency to be at or below the maximum operating frequency.

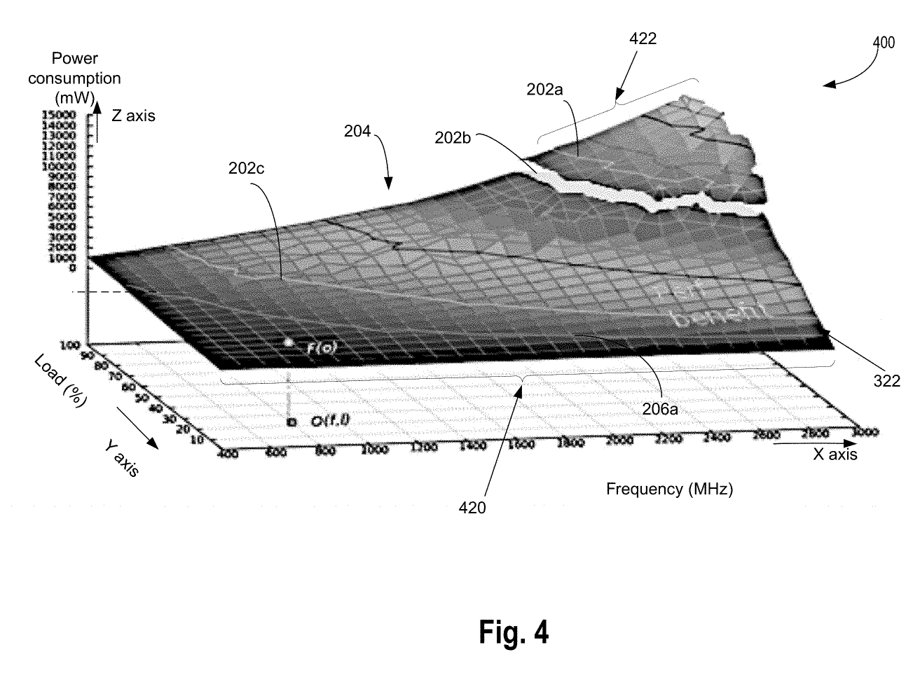

FIG. 4 illustrates a 3D plot 400 depicting a relationship between a frequency, a load and a power consumption of a processing core, where the plot 400 is chopped along an isometric power consumption line 202b, according to some embodiments. The plot 400 of FIG. 4 is at least in part similar to the plot 200 of FIG. 2. For example, the plot 400 includes the isometric power consumption lines 202a, 202b, and 202c, and the isometric frequency line 206a. Additionally, the X, Y and Z axes and the surface 204 in both the plots 200 and 300 are similar, and are represented using similar labels.

The plot 400 of FIG. 4 is chopped in two regions along the isometric power consumption line 202b, thereby dividing the surface 204 is a first region 420 and a second region 422. Points within the first region 420 has power consumption below the power consumption of the isometric power consumption line 202b, e.g., below about 9500 mW. Points within the second region 422 has power consumption above the power consumption of the isometric power consumption line 202b, e.g., above 9500 mW.

In some embodiments, the core 104 of FIG. 1 is configured to normally operate within the region 420. Normal or regular operation (or active regular mode of operation, or normal or regular range of operation) implies that the core 104 is active (e.g., not in a power saving mode or a sleep mode of operation), but not operating in a turbo boost mode. While operating under the turbo boost node, the core 104 can temporarily operate in the region 422.

In some embodiments, the logic 112 determines a normal range of operation of the core 104, i.e., identifies the region 420. In some embodiments, the logic 116 determines an operational point within the region 420, e.g., determines a frequency and a load for the core 104 that is within the region 420. Such determination can be based on a variety of factor, e.g., thermal management, resource demand of the core 104, etc. Once the logic 116 determines an appropriate operational point within the region 420, the core 104 operates in that operation point.

Thus, as discussed with respect to FIG. 4, the normal operation of the core 104 is limited by a maximum power consumption, and not by a maximum frequency (e.g., not limited by the HFM frequency). This allows the core 104 to operate at higher frequencies (e.g., compared to the operation of a conventional system discussed with respect to FIG. 3, where the normal operating frequency has to be less than the frequency of the isometric frequency line 206a), yet all these additional operating points are still under a maximum power envelop. This allows the logic 116 to choose a frequency that fits the operating load demand, as long as the power consumption limit is not breached. This, for example, improves a performance of the core for a given load range. As an example, short burst of low-load tasks that are frequency scalable can perform at a relatively high frequency, thereby favoring performance, without worrying about any maximum frequency, e.g., as long as the power consumption is below the maximum power consumption associated with the isometric power line 202b. Such operation is, however, not feasible with a conventional system discussed with respect to FIG. 3, which has a maximum frequency limit.

In some embodiments, identifying the region 420 and operating the core 104 within the region 420 can be done in one of numerous manners. Merely as an example, the logic 112 of FIG. 1 can store a table or map of a plurality of points along the isometric power consumption line 202b. For example, the logic 112 of FIG. 1 can store a plurality of pairs of frequency and load points along the line 202b. The logic 116 can determine an operational point for the core 104, e.g., based on the plurality of points along the isometric power consumption line 202b, as stored by the logic 112. For example, the logic 116 can ensure, based on the plurality of points along the isometric power consumption line 202b, that the operating point normally stays within the region 420.

In some other embodiments, instead of (or in addition to) storing the plurality of points along the isometric power consumption line 202b, the logic 112 generates or receives a mathematical function that approximately or substantially defines the isometric power consumption line 202b. The mathematical function can be an appropriate non-linear function that somewhat resembles the line 202b. Once the logic 112 has access to the mathematical function, the logic 112 can identify the range 420, based on the mathematical function. Accordingly, the logic 116 can select an operating point of the core 104 based on the identified region 420.

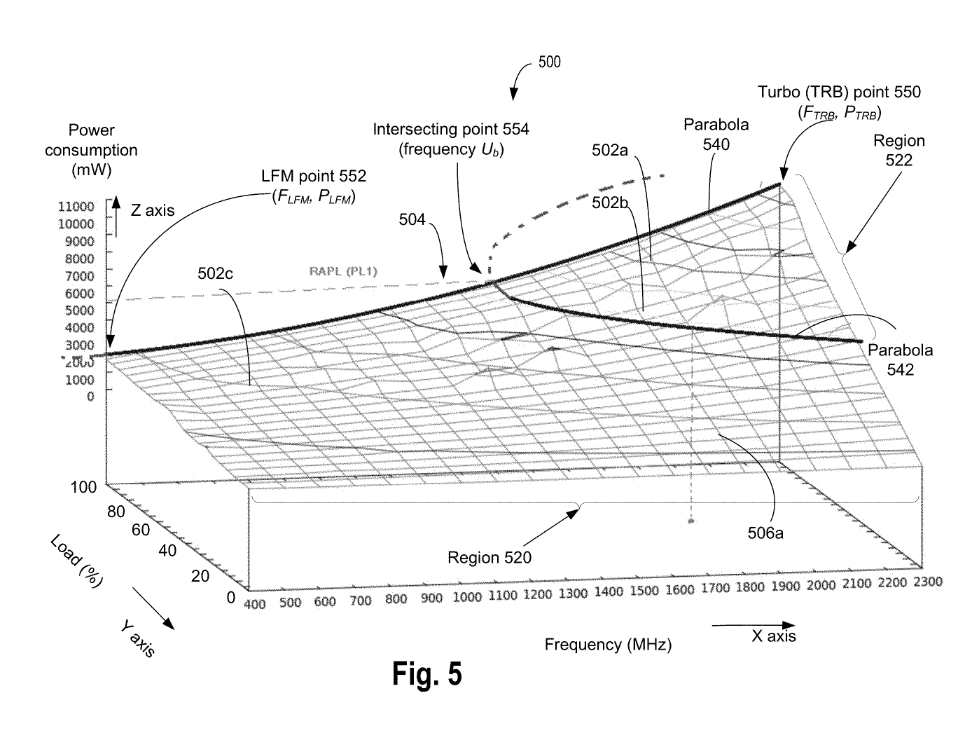

FIG. 5 illustrates a plot 500 of a power surface 504 (henceforth also referred to herein as “surface 504”) of a processing core (e.g., the core 104), with parabolas 540 and 542 being overlaid on the surface 504, according to some embodiments. The surface 504 is at least in part similar to the surface 204 of FIGS. 2-4. Similar to FIGS. 2-4, the X, Y and Z axis in FIG. 5 respectively represent the frequency (in MHz), load (in percentage), and power consumption (in mW). Note that the X and Z axes values in FIG. 5 are different from those is FIGS. 2-4, e.g., due to the manner in which the plots in various figures were generated—however, such differences do not have any significance on the teachings of this disclosure.

The plot 500 illustrates a plurality of isometric power consumption lines, e.g., lines 502a, 502b, and 502c (note that the line 502b is not clearly visible in FIG. 5, e.g., partly because the line 502 is drawn using a light shade and partly because the parabola 542 is substantially overlaid on the line 502b). Similarly, the plot 500 illustrates a plurality of isometric frequency lines, e.g., line 506a. The plot 500 also illustrates a plurality of isometric load lines, although such lines are not labeled in FIG. 5.

In some embodiments, an isometric power consumption line, e.g., the line 502b, defines two regions 520 and 522 on the surface 504. For example, the line 502b forms a boundary between the regions 520 and 522. In some embodiments, as discussed with respect to FIG. 4, the core 104 is to normally operate in the region 520 (although, for example, the core 104 can temporarily operate in the region 522 during a turbo boost mode). For example, a power consumption of the line 502b forms a threshold power consumption or a maximum power consumption of the core 104 during a regular active operation of the core 104.

In some embodiments, given a power limit envelop (e.g., given the boundary of the region 520 defined by the isometric power consumption line 502b), two attributes can be used to find an operating point O(f,l). A first attribute, for example, is a contour of limiting governance, e.g., a function between frequency & load for given Z axis power consumption plane. A second attribute, for example, is an applicable load limit for that z axis power consumption plane, e.g., a function between the power consumption and the frequency at 100% load.

In the plot 500, a mathematical function is defined, where the mathematical function approximates the boundary line 502b. For example, as illustrated in FIG. 5, the line 502b has approximately a shape of a parabola. Accordingly, a parabola 542 is superimposed on the line 502b, and defines the line 502b. Note that the parabola 542 may not exactly track the line 502b, but somewhat tracks the line 502b.

Another parabola 540 approximately tracks an edge of the surface 504. The edge of the surface tracked by the parabola 540, for example, represents an isometric load line corresponding to the 100% load.

It is to be noted that because the parabola 540 tracks an isometric load line, the parabola 540 lies in the plane defined by the X axis and the Z axis (e.g., has substantially similar Y axis value at all points along the parabola 540). For example, the parabola 540 is vertical with respect to the X-Y plane. On the other hand, because the parabola 542 tracks an isometric power consumption line, the parabola 542 lies in the plane defined by the X axis and the Y axis (e.g., has substantially similar Z axis value at all points along the parabola 542). For example, the parabola 542 is horizontal with respect to the X-Y plane.

As discussed herein above, although the core 104 normally operates in the region 520, in some embodiments, the core 104 can operate in the region 522, e.g., when the core 104 is operating in a turbo boost mode. An operating point having a maximum possible frequency and a maximum possible load (e.g., at 100% load) in the region 522 is also referred to herein as a turbo point (TRB) 550. As illustrated in FIG. 5, the TRB point 550 also has a maximum power consumption in the surface 504. The frequency and power consumption at the TRB point 550 is referred to herein as F_{TRB}, and P_{TRB}.

A lowest frequency at which the core 104 can operate is, for example, referred to as a Lowest Frequency Mode (LFM) frequency (e.g., F_{LFM}). In the plot 500, the LFM frequency at 100% load is referred to as a LFM point 552. The frequency and power consumption at the LFM point 552 is referred to herein as F_{LFM}, and P_{LFM}.

It is to be noted that the TRB point 550 and the LFM point 552 lies on the parabola 540. Also, the load at these two points are 100%.

In some embodiments, the point at which the two parabolas 540 and 542 intersect is also referred to herein as an intersection point 554. The frequency at this point 554 is also referred to as a base frequency, or U_{b}, and the load at this point is 100%. Frequencies along the parabola 540 is also referred to as base frequencies u_{b}.

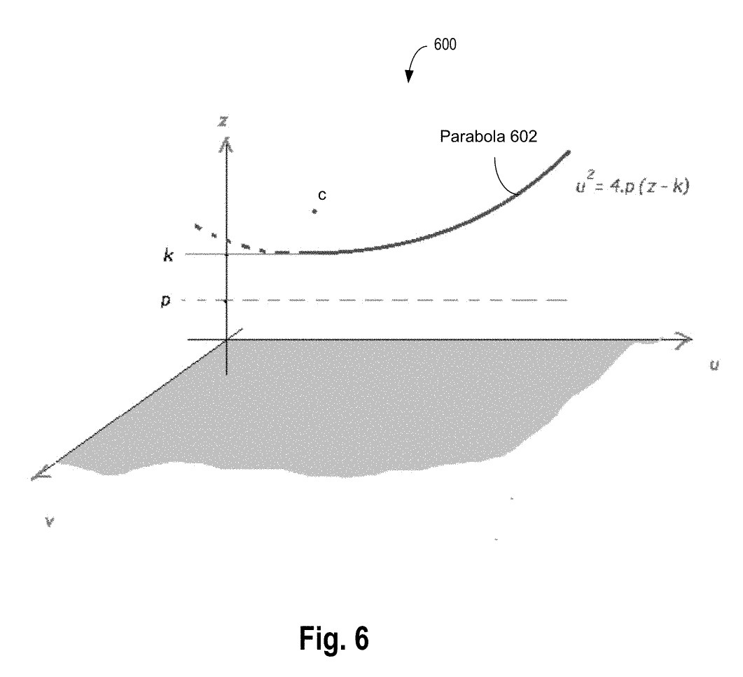

In some embodiments, due to the quadratic nature of the parabolas 540 and 542, most of the mathematical relations can approximately, yet, simplistically be established starting with a generic parabolic function, with appropriate focal point and directrix adjustments. FIG. 6 illustrates a general parabola 602 in a u, v, and z plane, where the U axis corresponds to the frequency axis (or X axis) of FIG. 5, where the V axis corresponds to the load axis (or Y axis) of FIG. 5, and where the Z axis corresponds to the power consumption axis (or Z axis) of FIG. 5.

In FIG. 6, consider the parabola 602 with a focal point at point “C,” a Vortex line at k, and a directrix at p. As discussed above, u is frequency axis and v is the load axis. The generic equation for parabola 602 relating base frequencies (u_{b}) to power consumption (z) is:

u_{b}²=4p₁·(z−k₁), Equation 1

where p₁ and k₁ are constants.

In some embodiments, the parabola 602 corresponds to the parabola 540 of FIG. 5 (that is, the parabola 602 is a generic representation of the parabola 540). Referring again to FIG. 5, the LFM point 552 and the TRB point 550 lies on the parabola 540. Thus, using the frequencies and power consumptions at the LFM point 552 and the TRB point 550, the constants p₁ and k₁ of equation 1 can be derived as follows:

k₁=(F_{TRB}²·P_{LFM}−F_{LFM}²·P_{TRB})/(F_{TRB}²−F_{LFM}²), Equation 2

p₁=F_{TRB}²/4(·P_{TRB}−k₁). Equation 3

Thus, the values from equations 2 and 3 are plugged in equation 1, and the equation 1 defines the parabola 540 of FIG. 5.

In equations 2 and 3, the values associated with the TRB point 550 and the LFM point 552 are used. However, in another embodiment, a frequency and a power consumption of any other appropriate point(s) can also be used instead, as long as the point(s) is on the parabola 540. For example, in equations 2 and 3, any frequency/power consumption pair for 100% load can be used instead of the frequency/power consumption pair of the TRB point 550 or the LFM point 552 (e.g., because such a point will also be on the parabola 540).

In some embodiments, equations for the parabola 542 can also be derived in a similar manner. Because the parabola 542 tracks the isometric power consumption line 502b, the parabola 542 lies in the plane defined by the X axis and the Y axis, and is horizontal with respect to the X-Y plane. For a load v, the parabola 542 at a given power consumption z and a base frequency of U_{b} is given by:

(100−v)²=4·p₂·(u−U_{b}), Equation 4.

For example, in equation 4, the term U_{b} is referred to as a shift of the parabola 542, and the term p₂ is referred to as a spread of the parabola 542. U_{b} is a constant, which can be derived from equation 1. For example, because the parabola 542 is horizontal, the parabola 542 is associated with a specific power consumption value. If that specific power consumption value is plugged as z is equation 1, then the value u_{b} from equation 1 is the U_{b} in equation 4. So, U_{b} is equation 4 refers to the base frequency of the intersection point 554, e.g., where the parabolas 540 and 542 intersect. Note that the intersection point 554 is the vortex of the parabola 542.

In some embodiments, instead of having a single fixed boundary between the regions 520 and 522, the boundary can be dynamically changed (e.g., thereby changing the regions 520 and 522). Thus, instead of a single parabola 540 corresponding to the isometric power consumption line 502b, there may be multiple parabolas corresponding to multiple isometric power consumption lines (e.g., isometric power consumption lines 502a, 502b, 502c, etc.)—based on the need of the core 104, thermal management and/or other factors, a suitable maximum power consumption requirement can be selected (which corresponds to selecting a corresponding isometric power consumption line, and hence a corresponding horizontal parabola). For example, by suitable selecting the values of U_{b} and p₂ in equation 4, the parabola 542 can be shifted to track any isometric power line (e.g., one of lines 502a, 502b, 502c, etc.).

The two extreme examples of the location of the parabola are: (i) when the parabola 542 passes through the LFM point 552, and (ii) when the parabola passes through a HFM point. A HFM point, for example, refers to a point where, at 100% load, as the frequency is increased, the core 104 reaches the maximum power level for normal (e.g., not turbo boost) operation of the core 104. In an example, the HFM point can be the intersection point 554. In another example, the HFM point can be where the line 502a intersects the parabola 540, and so on. Thus, the HFM point is a point along the parabola 540.

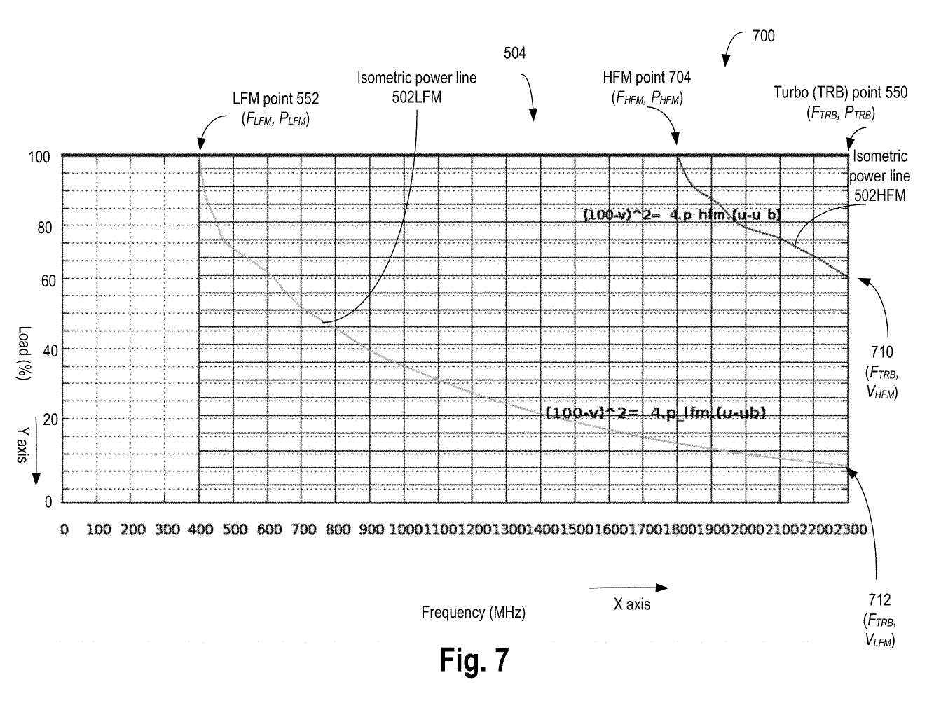

FIG. 7 illustrates a plot 700 that represents a top view of the plot 500 of FIG. 5, according to some embodiments. The X and Y axes, respectively representing the frequency and load, are visible in the plot 700. Because the plot 700 is a representation of the plot 500 as viewed from the top, the Z axis is not visible. Furthermore, the parabola 540 is only visible as a straight-line parallel to the X axis, corresponding to a 100% load (although the parabola 540 is not labeled separately in FIG. 7). The plot 700 further illustrates the turbo point 550 and the LFM point 552 of the plot 500 of FIG. 5.

Also illustrated in the plot is an example HFM point 704. As discussed herein above, the HFM represents a maximum frequency, along the 100% load line, that is desired for the regular or normal operation of the core 104 (e.g., based on a maximum power consumption for the regular or normal operation of the core 104). Two isometric power consumption lines 502LFM and 502HFM respectively passes through the LFM point 552 and the HFM point 704. Merely as an example, the line 502HFM corresponds to the line 502b of FIG. 5.

In some embodiments and as discussed herein above, the parabola 542 of FIG. 5 can have two extreme locations: (i) one passing through the HFM point 704 and overlaid on top of the line 502HFM, and (ii) one passing through the LFM 552 point and overlaid on top of the line 502LFM. Thus, the parabola 542 can be located in either of these two extreme locations, or can be located at any appropriate section in between.

If the parabola 542 passes through the HFM point 704, then the spread of the parabola 542 (e.g., the constant p₂ of equation 4) is denoted as p_{2HFM}. Let it be assumed that the parabola 542, when it passes through the HFM point 704, is parabola 542H (although the parabola 542H is not illustrated or labeled in the figures). Then, the equation of the parabola 542H would be (e.g., from equation 4):

(100−v)²=4·p_{2HFM}·(u−U_{b}). Equation 5a

Note that U_{b} is equation 5a is the base frequency value where the parabola 542H intersects the parabola 540, i.e., the frequency at the HFM point 704. Thus, the term U_{b} in equation 5a is F_{HFM}. Note that the HFM point 704 would be the vortex of the parabola 542H. Thus, the equation of the parabola 542H would be (e.g., from equation 5a):

(100−v)²=4·p_{2HFM}·(u−F_{HFM}). Equation 5b.

If the parabola 542 passes through the LFM point 552, then the spread of the parabola 542 (e.g., the constant p₂ of equation 4) is denoted as p_{2LFM}. Let it be assumed that the parabola 542, when it passes through the LFM point 552, is parabola 542L (although the parabola 542L is not illustrated or labeled in the figures). Then, the equation of the parabola 542L would be (e.g., from equation 4):

(100−v)²=4·p_{2LFM}·(u−U_{b}). Equation 6a

Note that U_{b} in equation 6a is the vase frequency where the parabola 542L intersects the parabola 540, i.e., the frequency at the LFM point 552. Thus, the term U_{b} is equation 6a is F_{LFM}. Note that the LFM point 552 would be the vortex of the parabola 542L. Thus, the equation of the parabola 542L would be (e.g., from equation 6a):

(100−v)²=4·p_{2LFM}·(u−F_{LFM}). Equation 6b.

Also, as illustrated in FIG. 7, the line 502HFM passes through a point 710, where the frequency at 710 is the TRB point frequency F_{TRB}. Let the load at the point 710 be V_{HFM} (e.g., because the point 710 lies on the line 502HFM). Similarly, the line 502LFM passes through a point 712, where the frequency at 712 is the TRB point frequency F_{TRB}. Let the load at the point 712 be V_{LFM} (e.g., because the point 712 lies on the line 502LFM). The parabolas 542L and 542H respectively passes through the points 712 and 710 (and also passes through the LFM point 552 and the HFM point 704, respectively). Using the intercepts of the parabolas 542L and 542H respectively with the points 712 and 710 (and also with the LFM point 552 and the HFM point 704, respectively), the constants p_{2HFM} and p_{2LFM} can be derived from equations 5b and 6b, as follows:

p_{2HFM}=(100−V_{HFM})²/(4·(F_{TRB}−F_{HFM})). Equation 7.

p_{2LFM}·(100−V_{LFM})²/(4·(F_{TRB}−F_{LFM})) Equation 8.

Thus, equations 7 and 8 represents two extreme values of the spread p₂ of equation 4. The spread p₂ of equation 4 can be either of the two extreme spreads of equations 7 or 8, or have any in between value. In an example, as the spread of the parabola 542L passing through the LFM point 552 is lower than that of the parabola 542H passing through the HFM point 704, the value of p_{2LFM} is higher than the value of p_{2HFM}. In some situations, it may be desirable to have the parabola 542 passing at or near the parabola 542H, e.g., to increase the region 520 on which the processing core 104 can operate.

In some embodiments, the parabola 542 can be selected from a series of parabolas, with the parabolas 542H and 524L defining the two parabolas at the two extreme of the series. The specific parabola in this series, that is to be selected, can be defined by a user. For example, all these parabolas in the series of parabolas intercept the parabola 540 at some point. For example, the parabola 542H intercepts the parabola 540 at the HFM point 704, while the parabola 542L intercepts the parabola 540 at the LFM point 552.

As discussed before, u_{b} is the base frequency that defines where a parabola of the series of parabolas intercepts the parabola 540. For example, for the parabola 542H, the value of u_{b} is F_{HFM}; and for the parabola 542L, the value of u_{b} is F_{LFM}. A function g(u_{b}) is defined as follows:

$$g ( {u}_{b} ) = {p}_{2 LFM} - ( {p}_{{2}_{LFM}} - {p}_{{2}_{HFM}} ) \frac{( {u}_{b} - {F}_{LFM} )}{( {F}_{HFM} - {F}_{LFM} )} . \qquad Equation 9$$

Then equation 4 can be rewritten as:

$$u = \frac{{( 100 - v )}^{2}}{4. g ( {u}_{b} )} + {u}_{b} . \qquad Equation 10$$

Thus, equations 1 and 10, in combination, provides the equations of the two parabolas 540 and 542 that define the region 520, where the region 520 is an operating region of the core 104 under normal operating conditions. In equation 10, an appropriate value of a base frequency U_{b} can be selected (where the selected value represents the base frequency of the parabola 542 intersection the 100% load line), e.g., based on a maximum power consumption condition discussed herein above.

For example, when the teachings discussed above is applied to the surface 204 of FIG. 2, if a maximum power consumption of about 9500 mW is desired, U_{b} is selected to be the frequency of the point where the line 202b intercepts the 100% load line. On the other hand, if a maximum power consumption of about 10500 mW is desired, U_{b} is selected to be the frequency of the point where the line 202a intercepts the 100% load line.

In some embodiments, during an operation of the core 104, the value of U_{b} can be selected once (e.g., based on a type and specification of the core 104) and not changed. In some other embodiments, during an operation of the core 104, the initial value of U_{b} can be selected initially, and the value of U_{b} can be changed dynamically based on one or more factors, e.g., thermal management, age and deterioration of the core 104, computation workload of the core 104, user controller settings, and/or the like.

In FIG. 7, the parabola 542L corresponding to the line 502LFM is assumed to be an extreme parabola (e.g., on the low end) of the series of possible parabolas. However, for sustained low workloads (e.g., long duration of semi-active or low-active workload), it may be desirable to define the region 520 to have a boundary further below the line 502LFM.

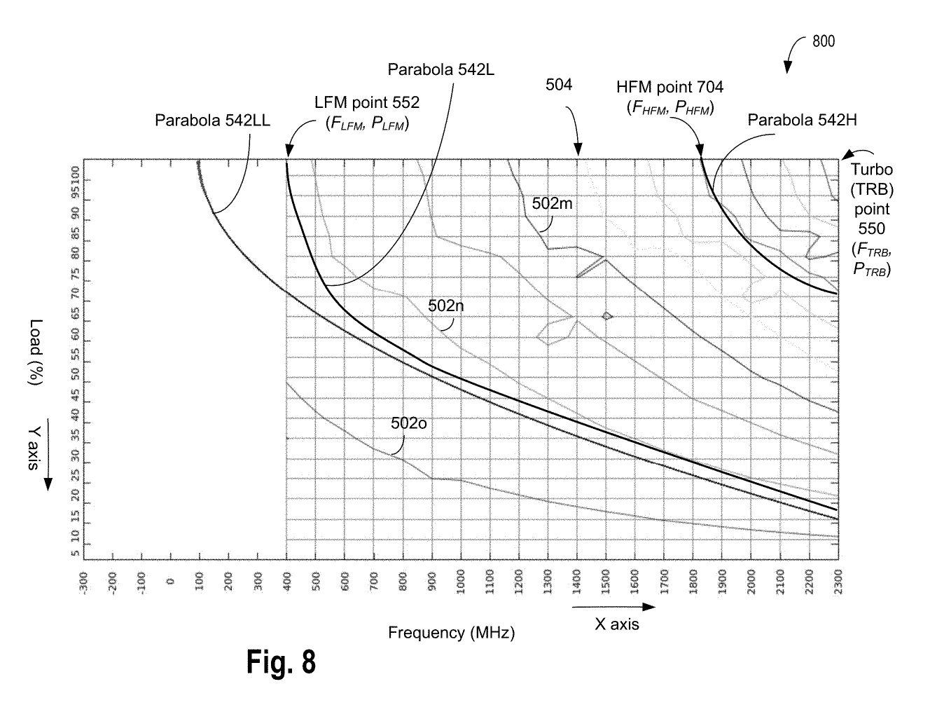

FIG. 8 illustrates a plot 800 that represents a top view of the plot 500 of FIG. 5, according to some embodiments. FIG. 8 is similar to the plot 700 of FIG. 7, and illustrates the LFM point 552, the HFM point 704, the parabolas 542L and 542H, and various isometric power consumption lines 502m, 502n, and 502o.

FIG. 8 also illustrates a parabola 542LL that intercepts the parabola 540 (e.g., intercepts the 100% load line) at a base frequency below the F_{LFM} frequency (although parabola 540 is not illustrated in FIG. 8). For example, the F_{LFM} frequency in FIG. 8 is 400 MHz, and the parabola 542LL intercepts the 100% load line at about 100 MHz (e.g., U_{b} for the parabola 542LL is 100 MHz).

In some embodiments, this mode of operation (e.g., power capping operation) allows the core 104 to operate at a power consumption envelop that is lower than the LFM power consumption. The workload scenario assumption here, for example, is that the computing workloads of the core 104 are relatively low and are frequency scalable. The ability to operate below the parabola 542LL allows low loads at higher frequency, thereby ensuring that the load scale continues to remain scaled down due to the frequency increase. This results in better performance for power consumption that is less than the LFM power consumption. An example of such application would be small form factor devices (e.g., fitness gadget monitoring foot-steps or heartbeat), where there is a long duration near-idle to lower semi-active workload, which can leverage from sub-LFM power consumption.

Although FIGS. 5-7 aims at fitting a parabola on an isometric power line, in some other embodiments, any other mathematical function (e.g., any appropriate non-linear function) can be used to model the isometric power line, thereby defining a boundary of the operational region 520 for the core 104. For example, in some embodiments, a series of straight lines can also be used to model the isometric power line defining the boundary between the regions 520 and 522.

There are many technical effects of the various embodiments. For example, conventional processing cores usually have a maximum frequency (HFM frequency) in which the processing cores normally operate (e.g., while it is not operating at a turbo boost mode). Such conventional system often advertises the HFM frequency in their specification. In contrast, the core 104 can go beyond the HFM frequency. The core 104 is not limited by a frequency—rather, the core 104 is limited by a better Qos criteria, e.g., a maximum power consumption by the core 104. Some of the embodiments discussed herein, for example, introduces well-quantified and pre-characterized power-awareness to platform software. The platform software, can, in turn leverage to coordinate system level power sharing & various runtime scenario specific orchestration.

In some embodiments, the mathematical equations defining the boundary between the regions 522 and 520 can be pre-loaded in the computing device 100 of FIG. 1. For example, the power surface 504 can be derived for a specific processing core, and the corresponding equations of the parabolas 540 and 542 can be generated for the specific processing core, thereby defining the region 520 of normal operation for the specific processing core. Subsequently, such equations can be applied to other processing cores that are of similar specification and type as the specific processing core. In such an example, the logic 112 of the computing device 100 can be pre-populated with the equations of the parabolas 540 and/or 542, thereby defining the region 520 within which the core 104 can normally operate. The logic 116 can access the equations and/or information associated with the region 520 in determining an operating point for the core 104. In an example, in such embodiments, the monitoring logic 108 may not be present in the computing device 100, or may not aid in generating the power surface 504.

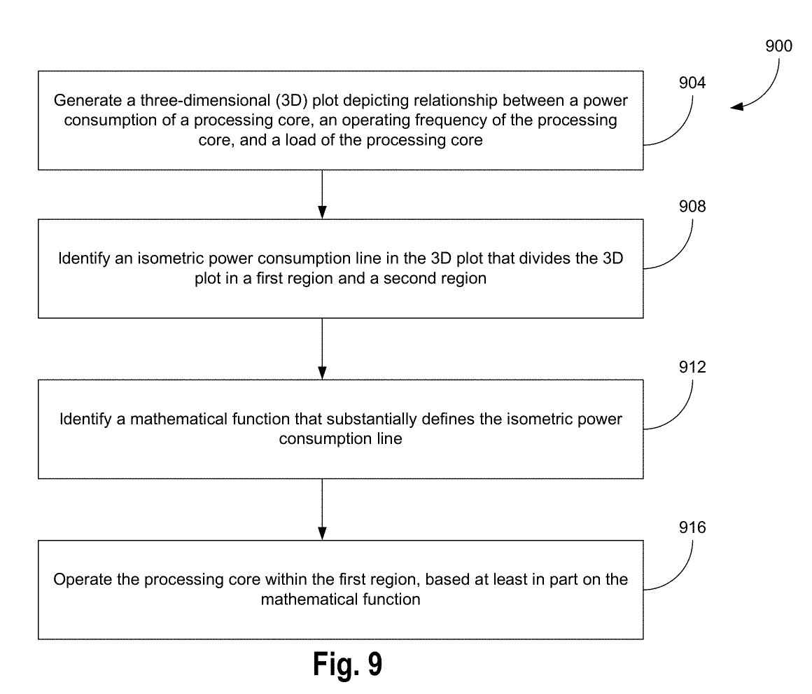

FIG. 9 illustrates a flowchart depicting a method 900 for determining an operating range of a processing core (e.g., the processing core 104 of FIG. 1) using a power consumption metric, according to some embodiments. At 904, a 3D plot (e.g., the plot 500 of FIG. 5) is generated (e.g., at least in part by the monitoring module 108). In an example, the 3D plot depicts a relationship between a power consumption of the processing core, an operating frequency of the processing core, and a load of the processing core.

At 908, an isometric power consumption line (e.g., line 502b of FIG. 5 and/or line 202b of FIG. 4) in the 3D plot is identified, where the isometric power consumption line divides the 3D plot in a first region and a second region (e.g., regions 520 and 522, respectively, of FIG. 5). A power consumption at the isometric power consumption line is a threshold power consumption or a maximum power consumption for the processing core for a regular active mode of operation.

At 912, a mathematical function that substantially defines the isometric power consumption line is identified (e.g., by the logic 112 of FIG. 1). Equations of the parabola 542 is an example of the mathematical function.

At 916, the processing core is operated within the first region, based at least in part on the mathematical function. For example, the logic 116 selects an operating point for an active regular operation of the processing core such that the operating point is within the first region, and the processing core operates at the selected operating point. In some embodiments, the mathematical function of 912 is determined apriori, e.g., prior to the operation of the processing core at 916.

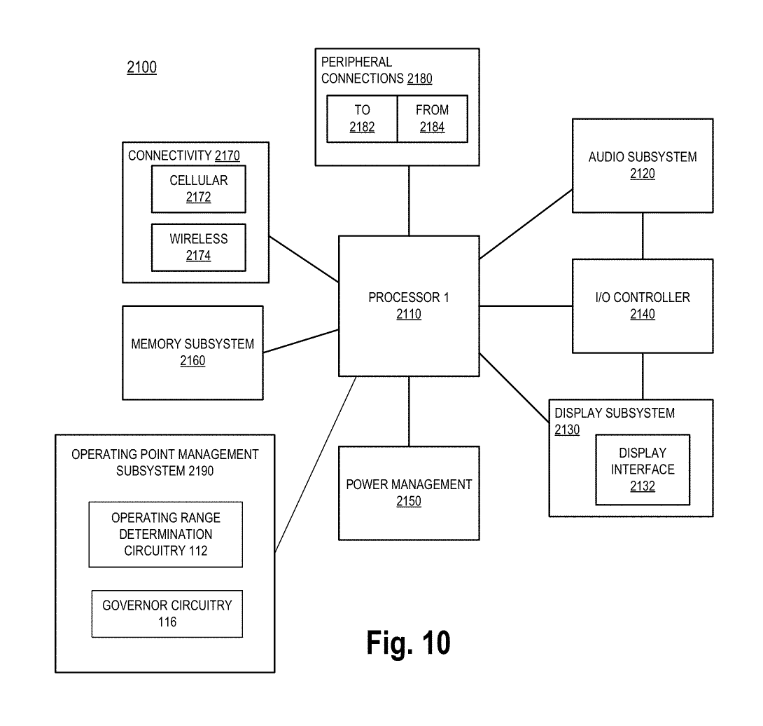

FIG. 10 illustrates a computing device 2100, a smart device, a computing device or a computer system or a SoC (System-on-Chip) 2100, where an operating point management subsystem 2190 manages an operating point for a processor 2110 of the computing device 2100, according to some embodiments. It is pointed out that those elements of FIG. 10 having the same reference numbers (or names) as the elements of any other figure can operate or function in any manner similar to that described, but are not limited to such.

In some embodiments, computing device 2100 represents an appropriate computing device, such as a computing tablet, a mobile phone or smart-phone, a laptop, a desktop, an IOT device, a server, a set-top box, a wireless-enabled e-reader, or the like. It will be understood that certain components are shown generally, and not all components of such a device are shown in computing device 2100.

In some embodiments, computing device 2100 includes a first processor 2110. The various embodiments of the present disclosure may also comprise a network interface within 2170 such as a wireless interface so that a system embodiment may be incorporated into a wireless device, for example, cell phone or personal digital assistant.

In one embodiment, processor 2110 can include one or more physical devices, such as microprocessors, application processors, microcontrollers, programmable logic devices, or other processing means. The processing operations performed by processor 2110 include the execution of an operating platform or operating system on which applications and/or device functions are executed. The processing operations include operations related to I/O (input/output) with a human user or with other devices, operations related to power management, and/or operations related to connecting the computing device 2100 to another device. The processing operations may also include operations related to audio I/O and/or display I/O.

In one embodiment, computing device 2100 includes audio subsystem 2120, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 2100, or connected to the computing device 2100. In one embodiment, a user interacts with the computing device 2100 by providing audio commands that are received and processed by processor 2110.

Display subsystem 2130 represents hardware (e.g., display devices) and software (e.g., drivers) components that provide a visual and/or tactile display for a user to interact with the computing device 2100. Display subsystem 2130 includes display interface 2132, which includes the particular screen or hardware device used to provide a display to a user. In one embodiment, display interface 2132 includes logic separate from processor 2110 to perform at least some processing related to the display. In one embodiment, display subsystem 2130 includes a touch screen (or touch pad) device that provides both output and input to a user.

I/O controller 2140 represents hardware devices and software components related to interaction with a user. I/O controller 2140 is operable to manage hardware that is part of audio subsystem 2120 and/or display subsystem 2130. Additionally, I/O controller 2140 illustrates a connection point for additional devices that connect to computing device 2100 through which a user might interact with the system. For example, devices that can be attached to the computing device 2100 might include microphone devices, speaker or stereo systems, video systems or other display devices, keyboard or keypad devices, or other I/O devices for use with specific applications such as card readers or other devices.

As mentioned above, I/O controller 2140 can interact with audio subsystem 2120 and/or display subsystem 2130. For example, input through a microphone or other audio device can provide input or commands for one or more applications or functions of the computing device 2100. Additionally, audio output can be provided instead of, or in addition to display output. In another example, if display subsystem 2130 includes a touch screen, the display device also acts as an input device, which can be at least partially managed by I/O controller 2140. There can also be additional buttons or switches on the computing device 2100 to provide I/O functions managed by I/O controller 2140.

In one embodiment, I/O controller 2140 manages devices such as accelerometers, cameras, light sensors or other environmental sensors, or other hardware that can be included in the computing device 2100. The input can be part of direct user interaction, as well as providing environmental input to the system to influence its operations (such as filtering for noise, adjusting displays for brightness detection, applying a flash for a camera, or other features).

In one embodiment, computing device 2100 includes power management 2150 that manages battery power usage, charging of the battery, and features related to power saving operation. Memory subsystem 2160 includes memory devices for storing information in computing device 2100. Memory can include nonvolatile (state does not change if power to the memory device is interrupted) and/or volatile (state is indeterminate if power to the memory device is interrupted) memory devices. Memory subsystem 2160 can store application data, user data, music, photos, documents, or other data, as well as system data (whether long-term or temporary) related to the execution of the applications and functions of the computing device 2100. In one embodiment, computing device 2100 includes a clock generation subsystem 2152 to generate a clock signal.

Elements of embodiments are also provided as a machine-readable medium (e.g., memory 2160) for storing the computer-executable instructions (e.g., instructions to implement any other processes discussed herein). The machine-readable medium (e.g., memory 2160) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 2170 includes hardware devices (e.g., wireless and/or wired connectors and communication hardware) and software components (e.g., drivers, protocol stacks) to enable the computing device 2100 to communicate with external devices. The computing device 2100 could be separate devices, such as other computing devices, wireless access points or base stations, as well as peripherals such as headsets, printers, or other devices.

Connectivity 2170 can include multiple different types of connectivity. To generalize, the computing device 2100 is illustrated with cellular connectivity 2172 and wireless connectivity 2174. Cellular connectivity 2172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 2174 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 2180 include hardware interfaces and connectors, as well as software components (e.g., drivers, protocol stacks) to make peripheral connections. It will be understood that the computing device 2100 could both be a peripheral device (“to” 2182) to other computing devices, as well as have peripheral devices (“from” 2184) connected to it. The computing device 2100 commonly has a “docking” connector to connect to other computing devices for purposes such as managing (e.g., downloading and/or uploading, changing, synchronizing) content on computing device 2100. Additionally, a docking connector can allow computing device 2100 to connect to certain peripherals that allow the computing device 2100 to control content output, for example, to audiovisual or other systems.

In addition to a proprietary docking connector or other proprietary connection hardware, the computing device 2100 can make peripheral connections 2180 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, the computing device 2100 comprises an operating point management subsystem 2190 configured to manage an operating point (e.g., an operating frequency and an operating load) of the processor 2110. In some embodiments, the operating point management subsystem 2190 comprises the operating range determination logic 112 and the governor logic 116 of FIG. 1 (and may also include the monitoring logic 108 of FIG. 1). In an example, the logic 112 determines an operating range (e.g., the region 520 of FIG. 5) for the processor 2110, and the logic 116 selects an operating point for the processor 2110 from the determined operating range.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following example clauses pertain to further embodiments. Specifics in the example clauses may be used anywhere in one or more embodiments. All optional features of the apparatus described herein may also be implemented with respect to a method or process.

Clause 1. An apparatus comprising: a processing core; and circuitry to select, for a first mode of operation of the processing core, a first operating point comprising a first operating frequency and a first operating load, based at least in part on a mathematical function that substantially defines variation of a frequency and a load of the processing core for a threshold power consumption, wherein the circuitry is to select the first operating point such that a first power consumption of the processing core at the first operating point is less than or equal to the threshold power consumption.

Clause 2. The apparatus of clause 1, wherein the circuitry is to further select, for a second mode of operation of the processing core, a second operating point comprising a second operating frequency and a second operating load, such that a second power consumption of the processing core at the second operating point is higher than the threshold power consumption.

Clause 3. The apparatus of clause 2, wherein: the first mode of operation is an active regular mode of operation of the processing core; and the second mode of operation is a turbo boost mode of operation of the processing core.

Clause 4. The apparatus of any of clauses 1-3, wherein the mathematical function comprises a first parabola that substantially follows an isometric power consumption line in a three-dimensional (3D) plot representing relationship between a power consumption of the processing core, the frequency of the processing core, and the load of the processing core.

Clause 5. The apparatus of clause 4, wherein: the mathematical function is a first mathematical function; and the circuitry is to further access a second mathematical function comprising a second parabola that substantially follows an isometric load curve at or near 100% load of the processing core in the 3D plot.

Clause 6. The apparatus of any of clauses 4 or 5, further comprising: another circuitry to monitor an operation of the processing core, wherein the 3D plot is plotted based at least in part on another circuitry monitoring the operation of the processing core.

Clause 7. The apparatus of any of clauses 1-3, wherein: the mathematical function divides a three-dimensional (3D) plot in a first region and a second region; and the 3D plot represents relationship between a power consumption of the processing core, the frequency of the processing core, and the load of the processing core.

Clause 8. The apparatus of clause 7, wherein: a first plurality of operating points within the first region has a corresponding first plurality of power consumption that are equal to, or lower than the threshold power consumption; and a second plurality of operating points within the second region has a corresponding second plurality of power consumption that are higher than the threshold power consumption.

Clause 9. The apparatus of clause 7, wherein the circuitry is to further select a plurality of operating points for the processing core during the first mode of operation, wherein each of the plurality of operating points is within the first region of the 3D plot.

Clause 10. The apparatus of any of clauses 1-9, wherein the first operating frequency exceeds a Highest Frequency Mode (HFM) frequency of the processing core.

Clause 11. A non-transitory computer-readable storage medium to store instructions that, when executed by a processor, cause the processor to: store a mathematical function that substantially defines variation of a frequency and a load of a processing core for a threshold power consumption; and select, for a first mode of operation of the processing core and based at least in part on the mathematical function, a first operating point comprising a first operating frequency and a first operating load, such that a first power consumption of the processing core at the first operating point is not higher than the threshold power consumption.

Clause 12. The non-transitory computer-readable storage medium of clause 11, wherein the instructions, when executed, further cause the processor to: select, for a second mode of operation of the processing core, a second operating point comprising a second operating frequency and a second operating load, such that a second power consumption of the processing core at the second operating point is higher than the threshold power consumption.

Clause 13. The non-transitory computer-readable storage medium of any of clauses 11-12, wherein: the mathematical function comprises a first parabola that substantially follows an isometric power consumption line in a three-dimensional (3D) plot representing relationship between a power consumption of the processing core, the frequency of the processing core, and the load of the processing core; the mathematical function is a first mathematical function; and the instructions, when executed, further cause the processor to: access a second mathematical function comprising a second parabola that substantially follows an isometric load curve at or near 100% load of the processing core in the 3D plot.

Clause 14. The non-transitory computer-readable storage medium of any of clauses 11-13, wherein the instructions, when executed, further cause the processor to: monitor an operation of the processing core; and generate the 3D plot based at least in part on monitoring the operation of the processing core.

Clause 15. The non-transitory computer-readable storage medium of any of clauses 11-12, wherein: the mathematical function divides a three-dimensional (3D) plot in a first region and a second region; the 3D plot represents relationship between a power consumption of the processing core, the frequency of the processing core, and the load of the processing core; a first plurality of operating points within the first region has a corresponding first plurality of power consumption that are equal to, or lower than the threshold power consumption; and a second plurality of operating points within the second region has a corresponding second plurality of power consumption that are higher than the threshold power consumption.

Clause 16. A system comprising: a processing core; a memory coupled to the processing core, the memory to store a mathematical function that substantially defines a boundary in a three-dimensional (3D) plot such that the boundary divides the 3D plot in a first region and a second region, wherein the 3D plot represents relationship between a power consumption of the processing core, an operating frequency of the processing core, and a load of the processing core, and wherein the boundary in the 3D plot represents a plurality of points in the 3D plot having substantially similar power consumption of the processing core; and logic to facilitate operation of the processing core within the first region during a first mode of operation, based at least in part on the mathematical function.

Clause 17. The system of clause 16, wherein the logic is to facilitate the operation of the processing core by: selecting an operating point within the first region; and facilitating the operation of the processing core at the selected operating point.

Clause 18. The system of any of clauses 16-17, wherein the logic is to: further facilitate operation of the processing core within the second region during a second mode of operation, based at least in part on the mathematical function.

Clause 19. The system of clause 18, wherein: the first mode of operation is an active regular mode of operation of the processing core; and the second mode of operation is a turbo boost mode of operation of the processing core.

Clause 20. The system of any of clauses 16-19, wherein the mathematical function comprises: a parabola that substantially follows an isometric power consumption line in the 3D plot.

Clause 21. A method comprising: storing a mathematical function that substantially defines a boundary in a three-dimensional (3D) plot such that the boundary divides the 3D plot in a first region and a second region, wherein the 3D plot represents relationship between a power consumption of a processing core, an operating frequency of the processing core, and a load of the processing core, and wherein the boundary in the 3D plot represents a plurality of points in the 3D plot having substantially similar power consumption of the processing core; and facilitating operation of the processing core within the first region during a first mode of operation, based at least in part on the mathematical function.

Clause 22. The method of clause 21, wherein facilitating operation of the processing core comprises: selecting an operating point within the first region; and facilitating the operation of the processing core at the selected operating point.

Clause 23. The method of any of clauses 21-22, further comprising: facilitating operation of the processing core within the second region during a second mode of operation, based at least in part on the mathematical function.

Clause 24. The method of clause 23, wherein: the first mode of operation is an active regular mode of operation of the processing core; and the second mode of operation is a turbo boost mode of operation of the processing core.

Clause 25. The method of any of clauses 21-24, wherein the mathematical function comprises: a parabola that substantially follows an isometric power consumption line in the 3D plot.

Clause 26. An apparatus comprising: means for storing a mathematical function that substantially defines a boundary in a three-dimensional (3D) plot such that the boundary divides the 3D plot in a first region and a second region, wherein the 3D plot represents relationship between a power consumption of a processing core, an operating frequency of the processing core, and a load of the processing core, and wherein the boundary in the 3D plot represents a plurality of points in the 3D plot having substantially similar power consumption of the processing core; and means for facilitating operation of the processing core within the first region during a first mode of operation, based at least in part on the mathematical function.

Clause 27. The apparatus of clause 21, wherein the means for facilitating the operation of the processing core comprises: means for selecting an operating point within the first region; and means for facilitating the operation of the processing core at the selected operating point.

Clause 28. The apparatus of any of clauses 26-27, further comprising: means for facilitating operation of the processing core within the second region during a second mode of operation, based at least in part on the mathematical function.

Clause 29. The apparatus of clause 28, wherein: the first mode of operation is an active regular mode of operation of the processing core; and the second mode of operation is a turbo boost mode of operation of the processing core.

Clause 30. The apparatus of any of clauses 26-29, wherein the mathematical function comprises: a parabola that substantially follows an isometric power consumption line in the 3D plot.

Clause 31. An apparatus comprising: means for performing the method in any of the clauses 21-25.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

We claim:

1. An apparatus comprising:
a processing core; and
circuitry to select, for a first mode of operation of the processing core, a first operating point comprising a first operating frequency and a first operating load, based at least in part on a mathematical function that substantially defines variation of a frequency and a load of the processing core for a threshold power consumption,
wherein the circuitry is to select the first operating point such that a first power consumption of the processing core at the first operating point is less than or equal to the threshold power consumption.

2. The apparatus of claim 1, wherein the circuitry is to further select, for a second mode of operation of the processing core, a second operating point comprising a second operating frequency and a second operating load, such that a second power consumption of the processing core at the second operating point is higher than the threshold power consumption.

3. The apparatus of claim 2, wherein:
the first mode of operation is an active regular mode of operation of the processing core; and
the second mode of operation is a turbo boost mode of operation of the processing core.

4. The apparatus of claim 1, wherein the mathematical function comprises a first parabola that substantially follows an isometric power consumption line in a three-dimensional (3D) plot representing relationship between a power consumption of the processing core, the frequency of the processing core, and the load of the processing core.

5. The apparatus of claim 4, wherein:
the mathematical function is a first mathematical function; and
the circuitry is to further access a second mathematical function comprising a second parabola that substantially follows an isometric load curve at or near 100% load of the processing core in the 3D plot.

6. The apparatus of claim 4, further comprising:
another circuitry to monitor an operation of the processing core, wherein the 3D plot is plotted based at least in part on another circuitry monitoring the operation of the processing core.

7. The apparatus of claim 1, wherein:
the mathematical function divides a three-dimensional (3D) plot in a first region and a second region; and
the 3D plot represents relationship between a power consumption of the processing core, the frequency of the processing core, and the load of the processing core.

8. The apparatus of claim 7, wherein:
a first plurality of operating points within the first region has a corresponding first plurality of power consumption that are equal to, or lower than the threshold power consumption; and
a second plurality of operating points within the second region has a corresponding second plurality of power consumption that are higher than the threshold power consumption.

9. The apparatus of claim 7, wherein the circuitry is to further select a plurality of operating points for the processing core during the first mode of operation, wherein each of the plurality of operating points is within the first region of the 3D plot.

10. The apparatus of claim 1, wherein the first operating frequency exceeds a Highest Frequency Mode (HFM) frequency of the processing core.

11. A non-transitory computer-readable storage medium to store instructions that, when executed by a processor, cause the processor to:
store a mathematical function that substantially defines variation of a frequency and a load of a processing core for a threshold power consumption; and
select, for a first mode of operation of the processing core and based at least in part on the mathematical function, a first operating point comprising a first operating frequency and a first operating load, such that a first power consumption of the processing core at the first operating point is not higher than the threshold power consumption.

12. The non-transitory computer-readable storage medium of claim 11, wherein the instructions, when executed, further cause the processor to:
select, for a second mode of operation of the processing core, a second operating point comprising a second operating frequency and a second operating load, such that a second power consumption of the processing core at the second operating point is higher than the threshold power consumption.

13. The non-transitory computer-readable storage medium of claim 11, wherein:
the mathematical function comprises a first parabola that substantially follows an isometric power consumption line in a three-dimensional (3D) plot representing relationship between a power consumption of the processing core, the frequency of the processing core, and the load of the processing core;
the mathematical function is a first mathematical function; and
the instructions, when executed, further cause the processor to:
access a second mathematical function comprising a second parabola that substantially follows an isometric load curve at or near 100% load of the processing core in the 3D plot.

14. The non-transitory computer-readable storage medium of claim 11, wherein the instructions, when executed, further cause the processor to:
monitor an operation of the processing core; and
generate the 3D plot based at least in part on monitoring the operation of the processing core.

15. The non-transitory computer-readable storage medium of claim 11, wherein:
the mathematical function divides a three-dimensional (3D) plot in a first region and a second region;
the 3D plot represents relationship between a power consumption of the processing core, the frequency of the processing core, and the load of the processing core;
a first plurality of operating points within the first region has a corresponding first plurality of power consumption that are equal to, or lower than the threshold power consumption; and
a second plurality of operating points within the second region has a corresponding second plurality of power consumption that are higher than the threshold power consumption.

16. A system comprising:
a processing core;
a memory coupled to the processing core, the memory to store a mathematical function that substantially defines a boundary in a three-dimensional (3D) plot such that the boundary divides the 3D plot in a first region and a second region, wherein the 3D plot represents relationship between a power consumption of the processing core, an operating frequency of the processing core, and a load of the processing core, and wherein the boundary in the 3D plot represents a plurality of points in the 3D plot having substantially similar power consumption of the processing core; and
logic to facilitate operation of the processing core within the first region during a first mode of operation, based at least in part on the mathematical function.

17. The system of claim 16, wherein the logic is to facilitate the operation of the processing core by:
selecting an operating point within the first region; and
facilitating the operation of the processing core at the selected operating point.

18. The system of claim 16, wherein the logic is to:
further facilitate operation of the processing core within the second region during a second mode of operation, based at least in part on the mathematical function.

19. The system of claim 18, wherein:
the first mode of operation is an active regular mode of operation of the processing core; and
the second mode of operation is a turbo boost mode of operation of the processing core.

20. The system of claim 16, wherein the mathematical function comprises:
a parabola that substantially follows an isometric power consumption line in the 3D plot.
